(19) United States
(12) Patent Application Publication
(10) Pub. No.: US 2015/0168951 A1
(43) Pub. Date: Jun. 18, 2015

(54) CONTROL ASSEMBLY FOR UNMANNED TESTING OF MACHINE OPERATION

(71) Applicant: Caterpillar Inc., Peoria, IL (US)

(72) Inventors: Thangavel Ganesan, Chennai (IN); Ponganesh Murugan, Chennai (IN); Saravanan Gopal, Chennai (IN)

(73) Assignee: Caterpillar Inc., Peoria, IL (US)

(21) Appl. No.: 14/631,893

(22) Filed: Feb. 26, 2015

(51) Int. Cl. G05D 1/00; G05B 15/02

(52) U.S. Cl. CPC G05D 1/0011; G05B 15/02

(57) ABSTRACT

A control assembly for testing an unmanned machine is provided. The control assembly includes a remote control device configured to generate a signal indicative of a user command. The control assembly also includes an actuation unit provided on-board the machine and being coupled to a lever. The lever is structured and arranged to initiate a machine operation through selective activation. The actuation unit includes a power source. The actuation unit also includes an actuating mechanism electrically connected to the power source and in engagement with the lever of the machine. The actuating mechanism is configured to move the lever. The control assembly further includes a testing module communicably coupled to the remote control device and the actuation unit. The testing module is configured to control an actuation of the actuation unit to move the lever based on the user command.

### TECHNICAL FIELD

The present disclosure relates to testing a machine's operation in an unmanned manner, and more particularly to a control assembly to carry out such testing.

### BACKGROUND

Machines, such as, excavators, are tested for performance before the machines are painted and shipped. Regarding machines which have a swiveling or rotatable cab such as, for example, a hydraulic excavator, one such testing process requires the cab portion of the machine to swing with respect to the undercarriage. An operator seated within the operator cabin may operate this swing operation of the machine. For example, it is not uncommon to require the cab of the machine to go through a full rotation for approximately up to 36 continuous revolutions. In such a situation, an operator present within the operator cabin may experience giddiness, nausea, and general discomfort due to this repetitive task.

U.S. Pat. No. 6,782,644 describes a hydraulic excavator having a remote control terminal for wirelessly maneuvering the hydraulic excavator. A display unit for displaying a positional relationship between the hydraulic excavator and the target excavation plane is further provided in the remote control terminal An operator can remotely set the target excavation plane while looking at a screen of the display unit, and also form the target excavation plane by remotely maneuvering the front working device using a joystick with the aid of a control function of an area limiting excavation controller. However, the remote controlling of the hydraulic excavator may incur additional costs as the front working device may need to be provided with additional circuitry and connections to receive signals from a control unit on-board the machine, in order to perform an excavation operation. Further, it may be difficult to employ such a remote control system onto an existing machine.

### SUMMARY OF THE DISCLOSURE

In one aspect of the present disclosure, a control assembly for testing an unmanned machine is provided. The control assembly includes a remote control device configured to generate a signal indicative of a user command. The control assembly also includes an actuation unit provided on-board the machine and being coupled to a lever. The lever is structured and arranged to initiate a machine operation through selective activation. The actuation unit includes a power source. The actuation unit also includes an actuating mechanism electrically connected to the power source and in engagement with the lever of the machine. The actuating mechanism is configured to move the lever. The control assembly further includes a testing module communicably coupled to the remote control device and the actuation unit. The testing module is configured to control an actuation of the actuation unit to move the lever based on the user command.

Other features and aspects of this disclosure will be apparent from the following description and the accompanying drawings.

### BRIEF DESCRIPTION OF THE DRAWINGS

FIG. 1 is a perspective view of a testing environment for an exemplary machine, according to one embodiment of the present disclosure;

FIG. 2 is a block diagram of an exemplary control assembly for remotely testing machine operation for the machine of FIG. 1; and

FIG. 3 is a perspective view of an actuation unit of the present disclosure control assembly positioned within an operator cabin of the machine for remotely testing the operation of the machine of FIG. 1.

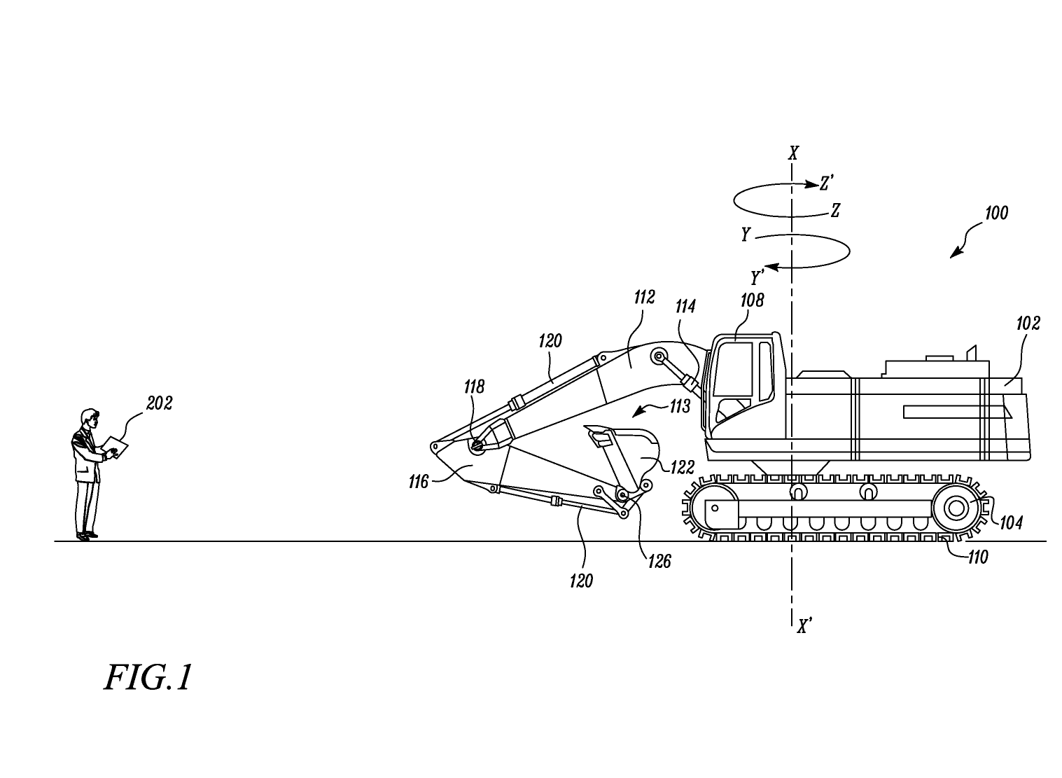

### DETAILED DESCRIPTION

Wherever possible, the same reference numbers will be used throughout the drawings to refer to the same or the like parts. FIG. 1 illustrates an exemplary machine 100, according to one embodiment of the present disclosure. The machine 100 is embodied as an excavator. It should be noted that the machine 100 may alternatively include other industrial machines, such as, for example, a back hoe loader, a shovel, or any other construction machine or machine having portions which move. It should be understood that the machine 100 may embody any wheeled or tracked machine associated with mining, agriculture, forestry, construction, and other industrial applications.

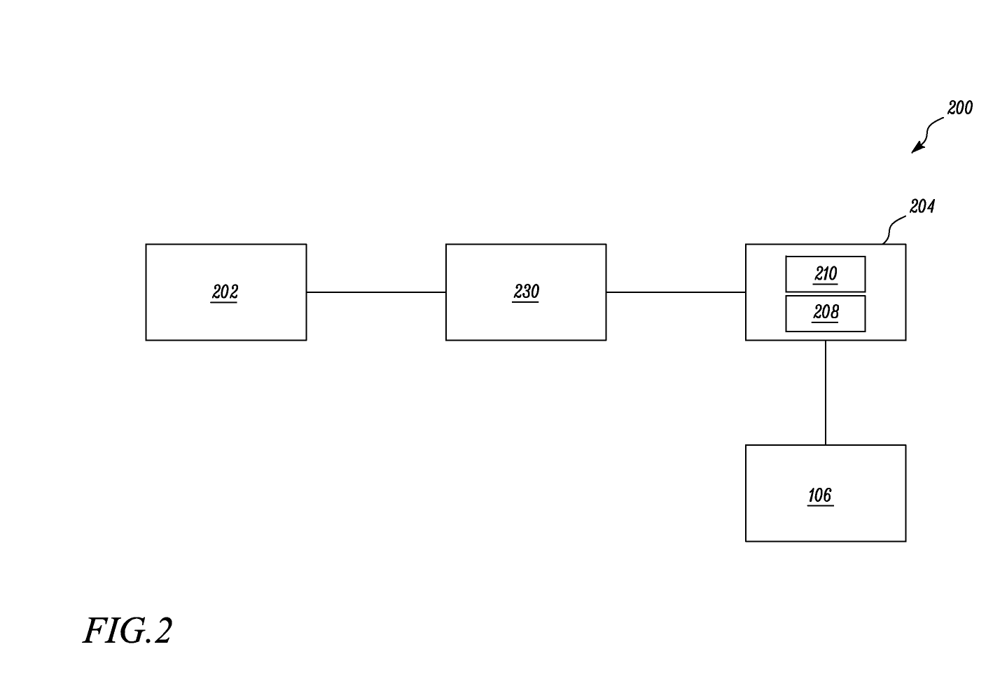

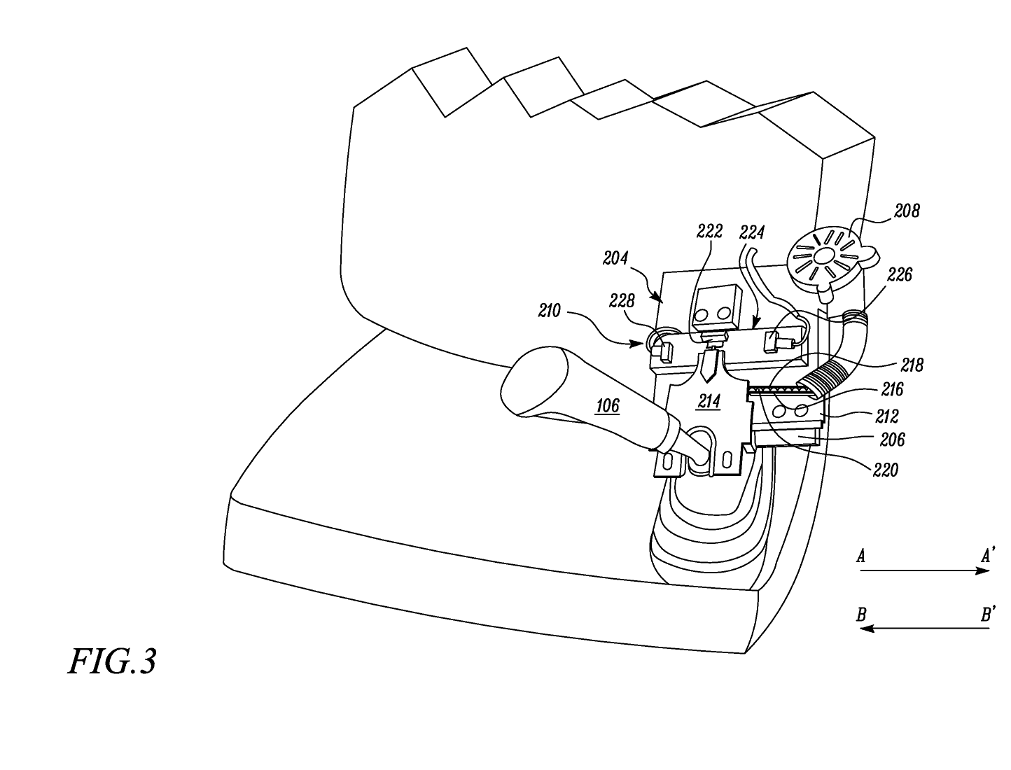

As shown in FIG. 1, the machine 100 has a body 102 that is rotatably mounted on an undercarriage system 104. During an operation of the machine 100, the body 102 of the machine 100 may swing or rotate through a full range of 360 degrees in either direction, with respect to the undercarriage system 104. The body 102 includes a drive motor mounted thereon which rotates a swing pinion through a speed reduction gear train of a transmission for selectively rotating the body 102 on the undercarriage system 104. The swing operation of the body 102 is controlled by a lever 106 (see FIGS. 2 and 3) positioned in an operator cabin 108 of the machine 100. It should be noted that the term “swing operation” used herein refers to full or partial rotation of the body 102 in a clockwise or anti-clockwise direction Y-Y′, Z-Z′ with respect to an axis X-X′. Further, an operation or movement of the lever 106 leads to the rotation of the body 102 in the clockwise or anti-clockwise direction Y-Y′, Z-Z′ about the axis X-X′. Further, the undercarriage system 104 includes tracks 110 for propulsion of the machine 100 on ground.

The machine 100 includes a linkage member, such as, a boom 112 which is pivotally mounted on the body 102. The boom 112 extends outwards from the body 102 of the machine 100. A hydraulic cylinder 114 (or a pair of cylinders), controlled by the operator or by a machine control system, is configured to move the boom 112 relative to the body 102 during operation. Also, a stick 116 is pivotally mounted at a pivot point 118 to an outer end of the boom 112. Similarly, a hydraulic cylinder 120 is used to move the stick 116 relative to the boom 112 about the pivot point 118 during excavation. Further, a bucket 122 is pivotally mounted at a pivot point 124 to an outer end of the stick 116. A hydraulic cylinder 126 moves the bucket 122 relative to the stick 116 about the pivot point 124 during the operation

The present disclosure is directed towards a control assembly 200, hereinafter interchangeably referred to as “external control assembly 200”, for remotely testing the swing operation of the machine 100. The control assembly 200 includes a remote control device 202 to test the swing operation of the body 102 of the machine 100 in both rotational directions Y-Y′, Z-Z′ to ensure proper swing operation of the operator cabin 108 relative to the undercarriage system 104. However, it should be noted that the application of the present disclosure is not limited to testing cab swivel and in fact may also control other movable portions of the machine 100 such as implements of the machine 100. For example, it is envisioned that the present disclosure external control assembly 200 may also be employed to test operation of the implements such as implement 113 (FIG. 1) and more specifically the operation of it's moving parts, such as, for example the boom 112, bucket 122, and stick 116 or any other linkages and/or implements which are movable and envisioned to be employed on the machine 100.

FIG. 2 is a block diagram of the control assembly 200 for remotely testing the swing operation of the machine 100, according to one embodiment of the present disclosure. The control assembly 200 includes the remote control device 202 (see FIGS. 1 and 2) and an actuation unit 204 which is mounted in the cabin (see FIG. 3) and will be described further hereinbelow. The remote control device 202 is configured to generate a signal indicative of a user command. The signal is indicative of an initiation of the rotation of the body 102 in the clockwise or anti-clockwise direction Y-Y′, Z-Z′. Further, in one embodiment, the signal may also be indicative of a stalling or an emergency shut-off of the machine 100. The remote control device 202 is operated from a location outside of the machine 100. In one example, the remote control device 202 may be operated from a distance of approximately up to 30 meters from the machine 100. The remote control device 202 may be any handheld device capable of sending signals to a location, over a network. Alternatively, the remote control device 202 may be hard wired to the actuation unit 204. The remote control device 202 may be embodied as any one of a mobile phone, a personal digital assistant, a notebook, tablet, and the like.

In one example, the remote control device 202 may include a first button (not shown) and a second button (not shown). On pressing the first button, the testing of the swing operation of the machine 100 is initiated. Whereas the second button, when pressed, is configured to initiate an emergency shut-off of the machine 100. It should be noted that the arrangement of buttons provided on the remote control device 202 disclosed herein is exemplary, and other arrangements of buttons known to those having ordinary skill are also contemplated by the present disclosure. In one example, the remote control device 202 may include a dedicated button for the rotation of the body 102 in the clockwise and anti-clockwise direction Y-Y′, Z-Z′.

Referring to FIGS. 2 and 3, the control assembly 200 includes the actuation unit 204 present on-board the machine 100. The term “on-board” referred to herein indicates that the actuation unit 204 is mounted on the machine 100. More particularly, the actuation unit 204 is present within the operator cabin 108 of the machine 100 (see FIG. 3). In one example, the actuation unit 204 is mounted on to a plank 206 (see FIG. 3), which in turn is removably mounted within the operator cabin 108. Further, the actuation unit 204 is in engagement with the lever 106, which is configured to perform the swing operation of the body 102. The actuation unit 204 is provided in a contacting relationship with the lever 106.

The actuation unit 204 includes a power source 208. The power source 208 is self actuated. Alternatively, the power source 208 may receive power from an external source. In one embodiment, the power source 208 receives power from the machine 100 itself. The power source 208 includes a motor. The motor may rotate in a clockwise direction or an anti clockwise direction, based on operational requirements. In one example, the motor may embody a D.C. motor. Alternatively, the power source 208 may include batteries or cells, or any device capable of power storage and supply.

The power source 208 is configured to actuate an actuating mechanism 210, wherein the actuating mechanism 210 is a part of the actuation unit 204. In one example, the actuating mechanism 210 is electrically connected to the power source 208. Alternatively, the power source 208 may be mechanically, pneumatically, or hydraulically coupled to the actuating mechanism 210. Referring to the accompanying figures, the actuating mechanism 210 includes a bracket 212. The bracket 212 includes a C-section, but not limited thereto. The bracket 212 is configured to receive a fork 214 and a slider arrangement 216 mounted thereon. The slider arrangement 216 includes a channel 218. The slider arrangement 216 further includes a screw 220. The screw 220 is provided within a passage of the channel 218. In one embodiment, the screw 220 is embodied as a helical screw, but not restricted thereto. The screw 220 is communicably coupled to the power source 208, such that an actuation of the power source 208 causes the screw 220 to rotate in a clockwise direction or an anti-clockwise direction, based on a rotation of the power source 208.

The screw 220 is configured to be coupled to the fork 214, such that a rotational motion of the screw 220 causes the fork 214 to move in a linear direction. The fork 214 is configured to slide along a length of the channel 218. In one example, when the screw 220 rotates in the clockwise direction, the fork 214 moves in a first direction A-A′ (see FIG. 3). Further, when the screw 220 rotates in the anti-clockwise direction, the fork 214 moves in a second direction B-B′ (see FIG. 3). It should be noted that the movement of the screw 220 and the corresponding movement of the fork 214 is exemplary and may vary based on the application.

As shown in the accompanying figures, the fork 214 is provided in surrounding contact with the lever 106. The movement of the fork 214 in the first and/or second direction A-A′, B-B′ leads to a movement or shifting of the lever 106, thereby causing the rotation of the body 102 in the clockwise or anti-clockwise direction Y-Y′, Z-Z′. The actuation unit 204 includes a sensor 222. The sensor 222 is positioned at an end 224 of the fork 214. The sensor 222 is configured to act as a circuit breaker in order to halt a movement of the fork 214, and thereby the lever 106.

The actuation unit 204 also includes a pair of sensors 226, 228. The sensors 226, 228 are provided at the end 224 of the fork 214. More particularly, the sensors 226, 228 are provided on either sides of the fork 214. During the movement of the fork 214 in the first and/or second direction A-A′, B-B′, the fork 214 contacts the respective sensor 226, 228. The sensors 226, 228 are configured to sense proximity of the fork 214 therefrom, and send out signals in order to avoid a travel of the fork 214 beyond a threshold limit. In one embodiment, the sensors 222, 226, 228 embody a limit switch. Alternatively, the sensor 222, 226, 228 may include a reed switch or a proximity switch, for example. The sensors 222, 226, 228 may include any device that detects a proximity of an object therefrom.

Referring to FIGS. 2 and 3, the external control assembly 200 includes a testing module 230. Based on the user command, the testing module 230 is configured to test the swing operation. The testing module 230 and the actuation unit 204 are externally provided in association with the machine 100 and may be detachable therefrom, without interfering with an internal circuitry of the machine 100.

The testing module 230 is communicably coupled to the remote control device 202 and the actuation unit 204. The testing module 230 is coupled to the actuation unit 204 and the remote control device 202 in a wired or wireless manner. The testing module 230 is configured to receive the signal indicative of the user command from the remote control device 202. The remote control device 202 sends the signals to the testing module 230, over a network. The network may be, but not limited to, a wide area network (WAN), a local area network (LAN), an Ethernet, an Internet, an Intranet, a cellular network, a satellite network, or any other suitable network for transmission of data. In various embodiments, the network may include a combination of two or more of the aforementioned networks and/or other types of networks known in the art. The remote control device 202 may transmit data using infrared, ultrasonic, wireless USB, Bluetooth, WI-FI, and the like.

Based on the user command, the testing module 230 is also configured to control an actuation of the actuation unit 204 in order to move the lever 106. On receipt of the signals from the remote control device 202, the testing module 230 sends signals to the actuation unit 204 to move the fork 214 in the first and/or second direction A-A′, B-B′.

Generally, the fork 214 is present in a neutral position during a non-testing period of the machine 100. Further, based on the signals received by the actuation unit 204, the fork 214 moves in the first or second directions A-A′, B-B′ respectively. The travel of the fork 214 is restricted by the sensors 226, 228. More particularly, the sensors 226, 228 are communicably coupled to the testing module 230. In a situation wherein the fork 214 moves in the first or second directions A-A′, B-B′ beyond any of the threshold limits, the sensors 226, 228 sends signals to the testing module 230 in order to deactivate the power source 208 of the actuation unit 204.

During the testing, the body 102 of the machine 100 rotates in either the clockwise or the anti-clockwise direction Y-Y′, Z-Z′ about the axis X-X′. In one example, the body 102 may be configured to complete approximately up to eighteen revolutions in the clockwise direction Y-Y′ and approximately up to eighteen revolutions in the anti-clockwise direction Z-Z′. The fork 214 and the lever 106 of the machine 100 moves in the first or second directions A-A′, B-B′ to rotate the body 102 in the clockwise or anti-clockwise directions Y-Y′, Z-Z′. In one example, a movement of the fork 214 in the first direction A-A′ may lead to a rotation of the body 102 of the machine 100 in the clockwise direction Y-Y′. When one revolution of the body 102 is complete, the fork 214 may be configured to move in a direction reverse to the first direction A-A′. Further, when the fork 214 is proximate to the sensor 222, the sensor 222 sends a signal to the testing module 230. Based on the signal received from the sensor 222, the testing module 230 is configured to send a deactivation signal to the power source 208. The next revolution of the body 102 in the clockwise or anti-clockwise direction Y-Y′, Z-Z′ may only start after a certain time period. In some situations, the time period may lie approximately between two seconds to ten seconds, based on system requirements.

The working of the testing module 230 described above is on an exemplary basis and does not limit the scope of the present disclosure. The number of rotations, order of the rotations, and so on may vary based on the application. Further, the actuation unit 204 described herein may be replaced by any other actuating device or components that may be fitted onto the lever 106 or control handle of the machine 100, in order to mechanically move the lever 106, based on the actuation of the actuating mechanism 210. Other components known in the art may be utilized to perform the described operations without deviating from the scope of the present disclosure.

As discussed above, the second button of the remote control device 202 is configured to send signals for the emergency shut-off of the machine 100. These signals are received by the testing module 230. Based on the signals received, the testing module 230 is configured to send deactivation signals to a relay of the machine 100 in order to shut-off the machine 100.

The testing module 230 may include an algorithm that is configured to perform the above described operational steps to test the swing operation of the machine 100. Alternatively, the testing module 230 may embody a single microprocessor or multiple microprocessors for receiving signals from the remote control device 202 and the sensors 222, 226, 228. Numerous commercially available microprocessors may be configured to perform the functions of the testing module 230. It should be appreciated that the testing module 230 may embody a machine microprocessor capable of controlling numerous machine functions.

### INDUSTRIAL APPLICABILITY

The present disclosure is directed towards the external control assembly 200 for use with an unmanned machine. The external control assembly 200 is configured to test the swing operation of the machine 100 from a location external to the machine 100. The external control assembly 200 includes the testing module 230 and the actuation unit 204. The testing module 230 and the actuation unit 204 are present on-board the machine 100. The testing module 230 and the actuation unit 204 are externally provided in association with the machine 100 and may be detachable therefrom, without interfering with the internal circuitry of the machine 100. The actuation unit 204 of the control assembly 200 is externally coupled to the lever 106 of the machine 100, so that the lever 106 may be moved by the user from outside of the machine 100 during testing.

Further, the external control assembly 200 includes the remote control device 202. The remote control device 202 allows for the testing of the swing operation of the machine 100 from the location external to the machine 100. The remote controlling of the swing operation of the machine 100 allows the user present outside the machine 100 to perform desired operations thereon. The external control assembly 200 of the present disclosure is cost effective and may be retrofitted to an existing machine without disturbing existing controls and connections of the respective machine.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A control assembly for testing of an unmanned machine, the control assembly comprising:
a remote control device configured to generate a signal indicative of a user command;
an actuation unit provided on-board the machine and being coupled to a lever, the lever being structured and arranged to initiate a machine operation through selective activation, the actuation unit comprising:
a power source; and
an actuating mechanism electrically connected to the power source and in engagement with the lever of the machine, the actuating mechanism configured to move the lever; and
a testing module communicably coupled to the remote control device and the actuation unit, the testing module being configured to:
receive the signal indicative of the user command; and
control an actuation of the actuation unit to move the lever based on the user command.
